(19) United States
(12) Patent Application Publication
(10) Pub. No.: US 2010/0326608 A1
(43) Pub. Date: Dec. 30, 2010

(54) SECURE LOCK FOR A LIFT CORD OF A WINDOW BLIND OR SHADE

(76) Inventors: Yu-Che Wen, Gueishan Township (TW); Ju-Sheng Cheng, Taichung City (TW); Kevin C. Huang, Taichung City (TW)

Correspondence Address: SINORICA, LLC, 2275 Research Blvd., Suite 500, ROCKVILLE, MD, 20850, US

(21) Appl. No.: 12/491,333

(22) Filed: Jun. 25, 2009

(51) Int. Cl. A47H 5/00; E06B 9/24

(52) U.S. Cl. 160/340

(57) ABSTRACT

The invention relates to a secure lock for a lift cord of a window blind or shade, which includes a head rail, a bottom rail and a shading unit combined between the head rail and the bottom rail. The shading unit has plural connecting members respectively engaging with an annular secure lock, except the connecting member positioned closest to the bottom rail engaging with a cap-shaped secure lock instead. A lift cord is strung in the annular secure locks, with the end fastened with the cap-shaped secure lock. An opening is formed in a ring of the annular secure locks and a groove formed in a curved portion of the cap-shaped secure lock. Thus, the lift cord can be released if an object is accidentally trapped between the lift cord and the shading unit, achieving a secure effect.

### BACKGROUND OF THE INVENTION

1. Field of the Invention

This invention relates to a secure lock for a lift cord of a window blind or shade.

2. Description of the Prior Art

Commonly, a conventional window blind or shade includes a head rail, a bottom rail and a shading unit combined between the head rail and the bottom rail. The shading unit is composed of a drape or a plurality of slats arrayed together, provided with plural steel rings employed for a lift cord to pass through to keep the shading unit to move up and down by moving the lift cord.

In order to prevent the lift cord from loosing to pose the shading unit unable to be smoothly commanded by the lift cord, the steel rings are completely formed as a closed circle. And, the end of the lift cord is usually tightened directly with the steel ring closest to the bottom rail, so that the lift cord is not apt to get loosened. However, in case that a child should have his neck accidentally surrounded and tightened by the lift cord, the child might be suffocated as the lift cord is not easy to get loosened from the steel ring. Especially, the child may get flurried to randomly tug anything because of panic, posing the lift cord to be tied up as the child is struggling, possible to be strangled. Therefore, it is really necessary to design a secure device enabling the lift cord to loose from it in case of any object trapped between the lift cord and the shading unit, preventing any accident from happening.

### SUMMARY OF THE INVENTION

The object of this invention is to offer a secure lock for a lift cord of a window blind or shade. The window blind or shade includes a head rail and a shading unit. The shading unit is mainly composed of a plurality of blinds folded and connected continuously together, and a plurality of connecting members respectively combined with an annular secure lock. The annular secure lock is replaced with a cap-shaped secure lock at the lowest connecting member when the shading unit is in an unfolded position. A lift cord is strung in the annular secure locks, with a stopper pivotally positioned inside the cap-shaped secure lock, so that the shading unit can be upwardly folded or downwardly unfolded by pulling or releasing the lift cord. The annular secure lock is provided with a ring having an inner annular surface and an outer annular surface, a locking portion jointed with the outer annular surface for locking with each connecting member of the shading unit, and an opening formed in the outer annular surface to correspond to the locking portion and to communicate with the inner annular surface. The cap-shaped secure lock is provided with a cap, an accommodating chamber internally surrounded by the cap for receiving the stopper of the lift cord, a through hole formed in the top of the cap to communicate with the accommodating chamber, and a groove formed in a curved portion. The groove has one end communicated with the through hole and the other end reached a bottom edge of the cap, so that the lift cord can enter the through hole via the groove. Further, the cap-shaped secure lock is also provided with a locking portion positioned on one side of the cap to correspond to the groove for engaging with each connecting member. Thus, when something is accidentally trapped between the lift cord and the shading unit, the lift cord can become curved and to be forced by a latitudinal component of force to slide to the opening of the annular secure locks and the groove of the cap-shaped secure lock, finally released from all of the secure locks to prevent a child (if something is a child) from suffocating or being tied up to death.

### BRIEF DESCRIPTION OF DRAWINGS

This invention is better understood by referring to the accompanying drawings, wherein:

FIG. 1 is a front view of a first preferred embodiment of a secure lock for a lift cord of a window blind in the present invention;

FIG. 2 is an exploded perspective view of a connecting member in the first embodiment;

FIG. 3 is a perspective view of a connecting member in a second preferred embodiment of the present invention;

FIG. 4 is an exploded perspective view of a connecting member in a third preferred embodiment of the present invention;

FIG. 5 is a top view of an annular secure lock in the first preferred embodiment of the present invention;

FIG. 6 is a side view of the annular secure lock in the first preferred embodiment of the present invention;

FIG. 7 is a perspective view of a cap secure lock in the first preferred embodiment of the present invention;

FIG. 8 is a cross-sectional view of the cap secure lock in the first preferred embodiment of the present invention;

FIG. 9 is a front view of the cap secure lock in the first preferred embodiment of the present invention;

FIG. 10 is a side view of a locking portion of the annular secure lock in a fourth preferred embodiment of the present invention;

FIG. 11 is a side view of a locking portion of the annular secure lock in a fifth preferred embodiment of the present invention;

FIG. 12 is a partial magnified cross-sectional view of the first preferred embodiment of a secure lock for a lift cord of a window blind in the present invention, showing it being used;

FIG. 13 is an illustrating view of the first preferred embodiment in the present invention, showing an object being trapped between the lift cord and the shading unit;

FIG. 14 is an illustrating view of the first preferred embodiment in the present invention, showing an object being trapped between the lift cord and the shading unit near a cap-shaped secure lock;

FIG. 15 is a front view of the annular secure lock of a sixth preferred embodiment in the present invention; and

FIG. 16 is a top view of the annular secure lock of the sixth preferred embodiment in the present invention.

### DETAILED DESCRIPTION OF THE PREFERRED EMBODIMENT

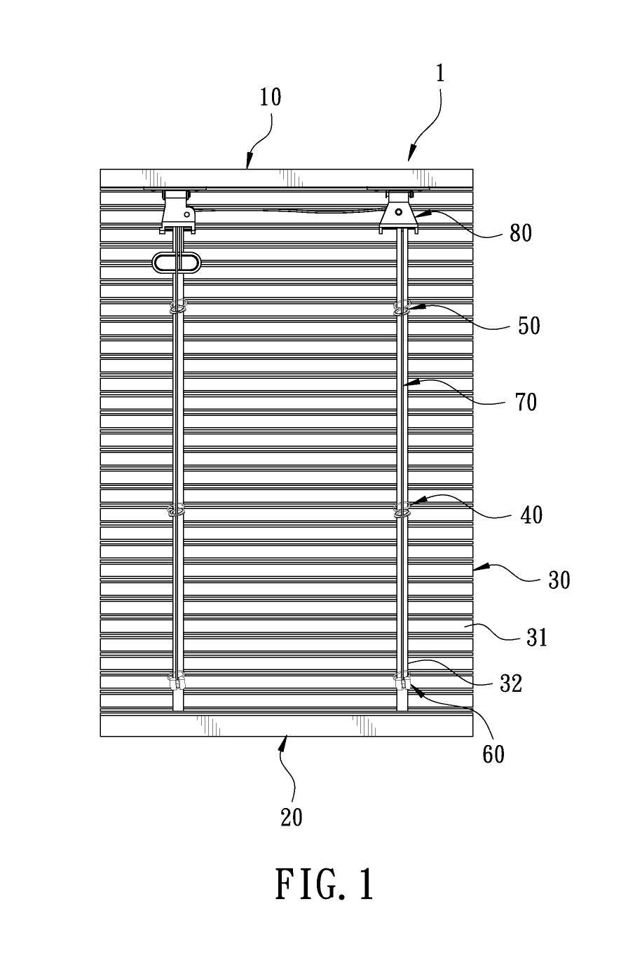

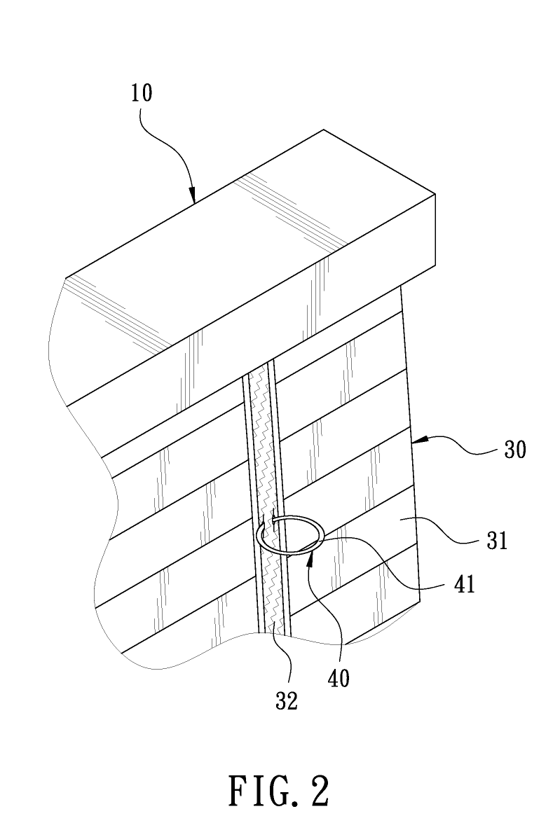

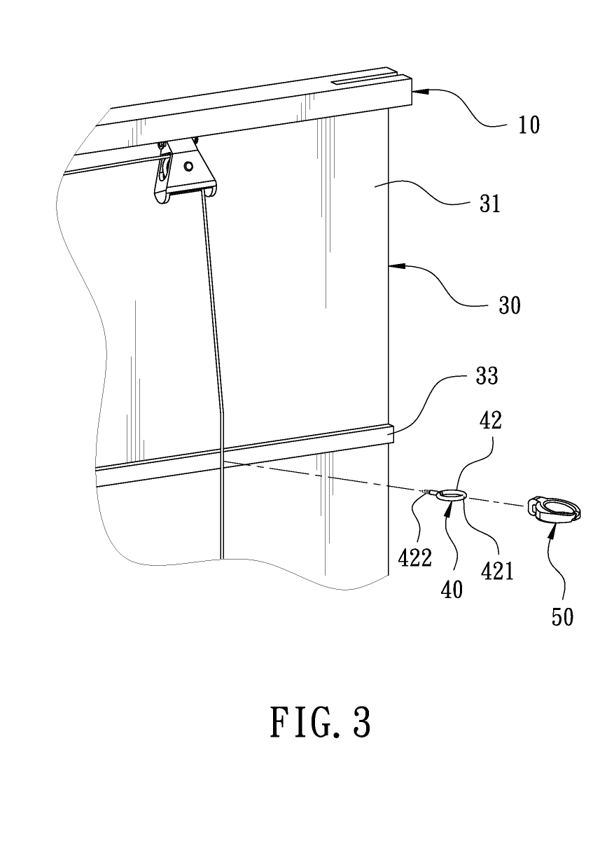

FIG. 1 shows a first preferred embodiment of a secure lock for a lift cord of a window blind 1 in the present invention. The window blind 1 includes a head rail 10, a bottom rail 20 and a shading unit 30 combined between the head rail 10 and the bottom rail 20. Vertically positioned in the shading unit 30 are a plurality of connecting members 40 that are properly spaced apart, with each of the connecting members 40 combined with an annular secure lock 50 and with the connecting member 40 located closest to the bottom rail 20 combined with a cap-shaped secure lock 60. A lift cord 70 are strung in the annular secure locks 50, with one end pivotally fastened with the cap secure lock 60 and the other end mounted on a pulley 80 positioned on the head rail 10. By means of the pulley 80, the shading unit 30 can be smoothly folded or unfolded. Next, as shown in FIG. 2, the shading unit 30 is provided with plural blinds 31 connected continuously together, and plural woven bands 32. Each of the connecting members 40 is formed of a ring 41, fastened in the woven bands 32. Further, as shown in FIG. 3, the shading unit 30 of a second preferred embodiment of the invention is provided with plural blinds 31 connected continuously together, and plural transversal strips 33 properly spaced apart. Each of the connecting members 40 is formed of an eye bolt 42, which is provided with a nearly C-shaped ring 421 formed at one side for locking with the annular secure lock 50 and a threaded portion 422 formed at the other side for engaging fixedly with the transversal strips 33. And, as shown in FIG. 4, each of the connecting members 40 of a third preferred embodiment of the invention is formed of a steel rod 43, which is axially fixed in the transversal strips 33 of the shading unit 30, with a U-shaped portion 431 formed at the intermediate section for locking with the cap-shaped secure lock 60.

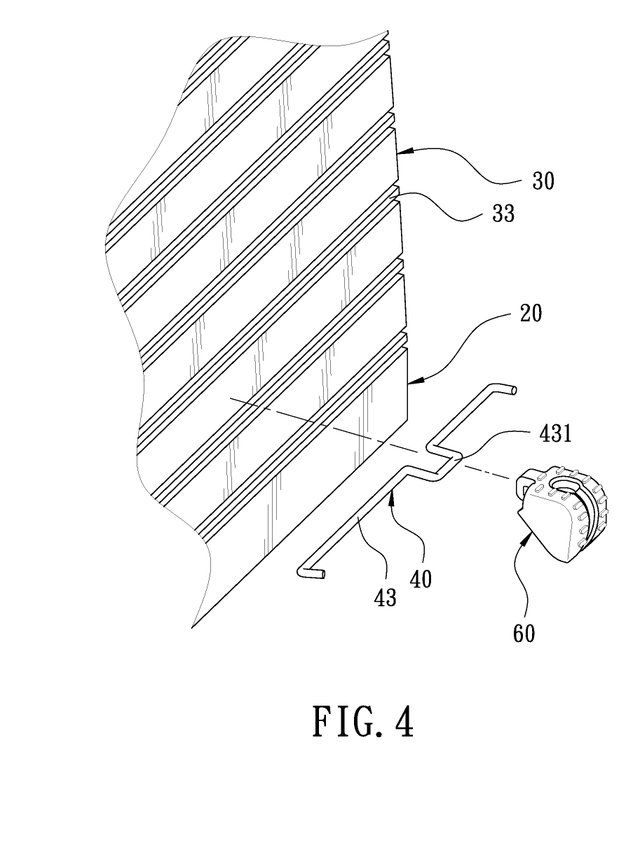

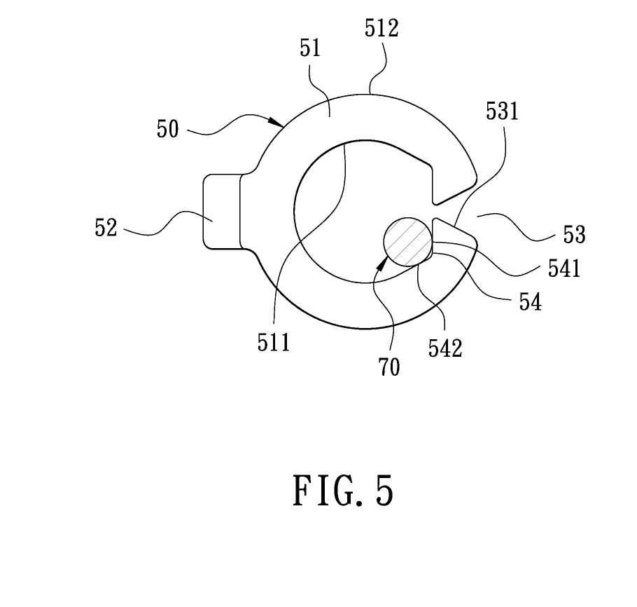

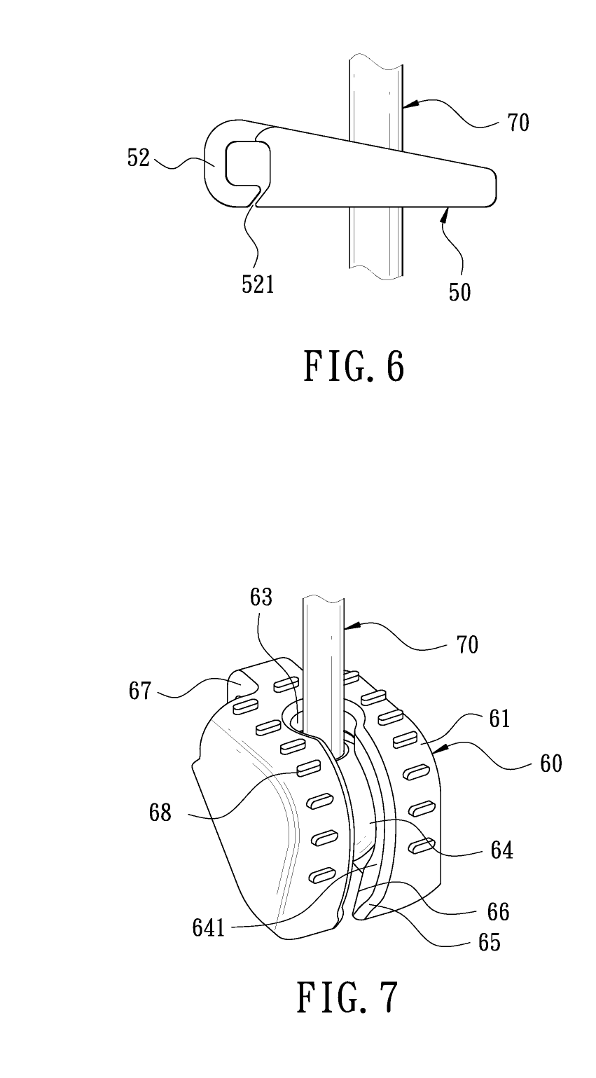

As shown in FIGS. 5 and 6, the annular secure lock 50 is provided with a ring 51 having an inner annular surface 511 and an outer annular surface 512, and a locking portion 52 jointed with the outer annular surface 512. The locking portion 52 is formed as a nearly C-shaped ring, provided with an engaging opening 521 for locking with the connecting members 40. The annular secure lock 50 is further provided with an opening 53 formed in the outer annular surface 512 to correspond to the locking portion 52 and to communicate with the inner annular surface 511. In this embodiment, the opening 53 is nearly V-shaped by gradually expanding from the inner annular surface 511 to the outer annular surface 512, axially parallel to the ring 51 so as to let the lift cord 70 easily slide into the ring 51. Respectively formed on two ends of the inner annular surface 511 next to two sides of the opening 53 is a blocking wall 54 that is composed of a first blocking surface 541 and a second blocking surface 542. The first blocking surface 541 has one end connected with a side surface 531 of the opening 53 and the other end connected with the second blocking surface 542. And, the width of the first blocking surface 541 and the second blocking surface 542 is almost the same as the outside diameter of the lift cord 70.

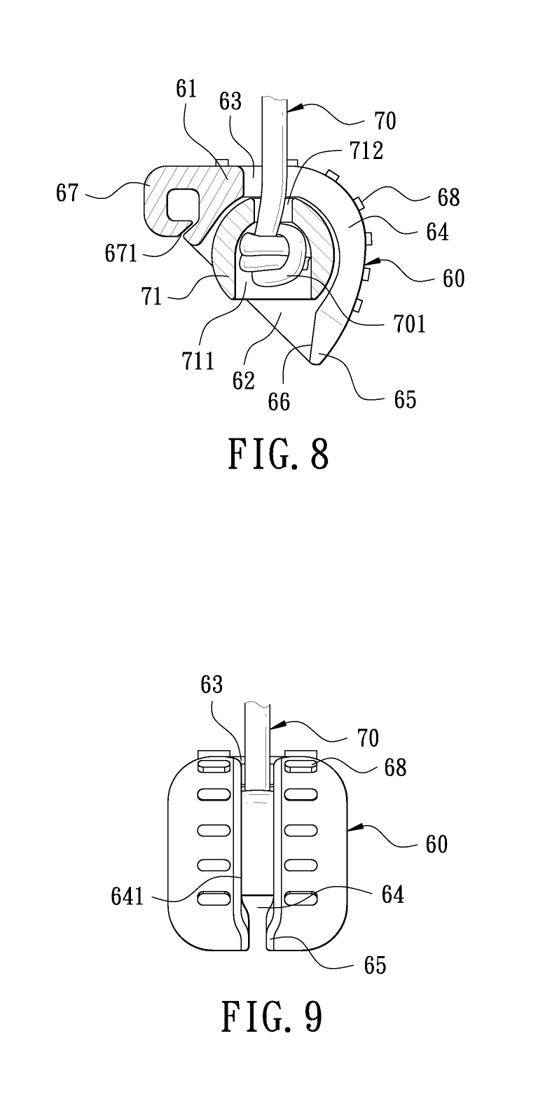

Next, FIGS. 7, 8 and 9 show the cap-shaped secure lock 60. First, as shown in FIG. 8, with a stopper 71 fastened with the end of the lift cord 70. The stopper 71 can be a secure ball. The secure ball 71 has the interior defined with an accommodating chamber 711 and has the head bored with a through hole 712 communicating with the accommodating chamber 711 so as to enable the end of the lift cord 70 to get into the accommodating chamber 711 through the through hole 712 to form a stop portion 701 that is pivotally connected with the secure ball 71. The stop portion 701 can be a cord knot. Referring to FIG. 7, the cap-shaped secure lock 60 is provided with a cap 61, an accommodating chamber 62 internally surrounded by the cap 61, as shown in FIG. 8, for accommodating the secure ball 71 of the lift cord 70, a through hole 63 formed in the top of the cap 61 to communicate with the accommodating chamber 62, and a groove 64 formed in a curved portion. The groove 64 has one end communicated with the through hole 63 and the other end reached a bottom edge of the cap 61, so that the lift cord 70 can enter the through hole 63 via the groove 64. Respectively formed close to a bottom edge of two inner surfaces 641 of the groove 64 is a blocking portion 65, which is a projected edge in the embodiment. A slope 66 is formed at a side surface of the blocking portion 65 near to the accommodating chamber 62. Further, the cap-shaped secure lock 60 is also provided with a locking portion 67 positioned on one side to correspond to the groove 64 with an engaging opening 671 for engaging with the connecting members 40 shown in FIG. 1, and a plurality of anti-slipping members 68 formed around the through hole 63 and the groove 64. In the embodiment, the anti-slipping members 68 are formed as projections.

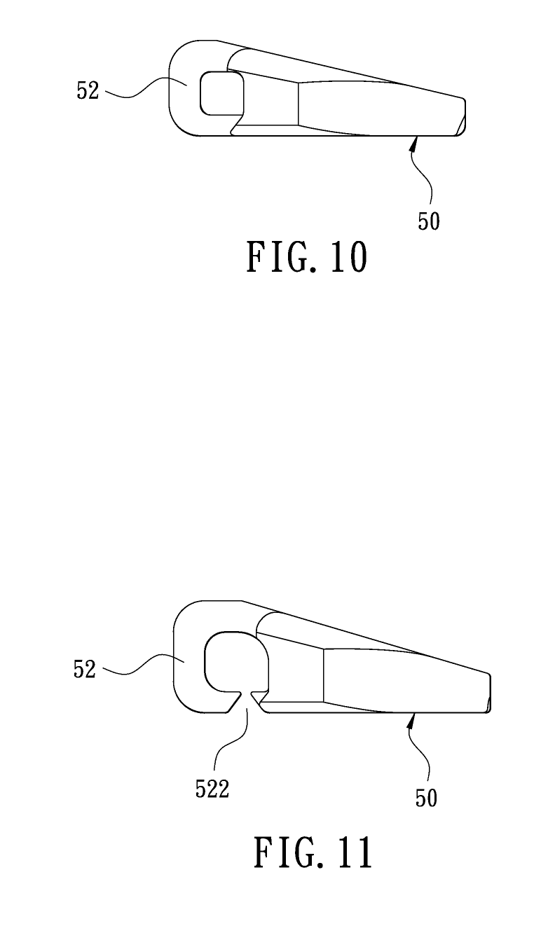

Further, FIGS. 10 and 11 show a fourth and a fifth preferred embodiments in the present invention. As shown in FIG. 10, the locking portion 52 is a completely sealed ring so that the strength can be boosted. As for the locking portion 52 shown in FIG. 11, it is provided with an engaging opening 522 shaped to outwardly expand from an inner annular surface to an outer annular surface for engaging with the connecting members 40 shown in FIG. 1. Accordingly, the locking portion 67 of the cap-shaped secure lock 6 can be alike designed as well.

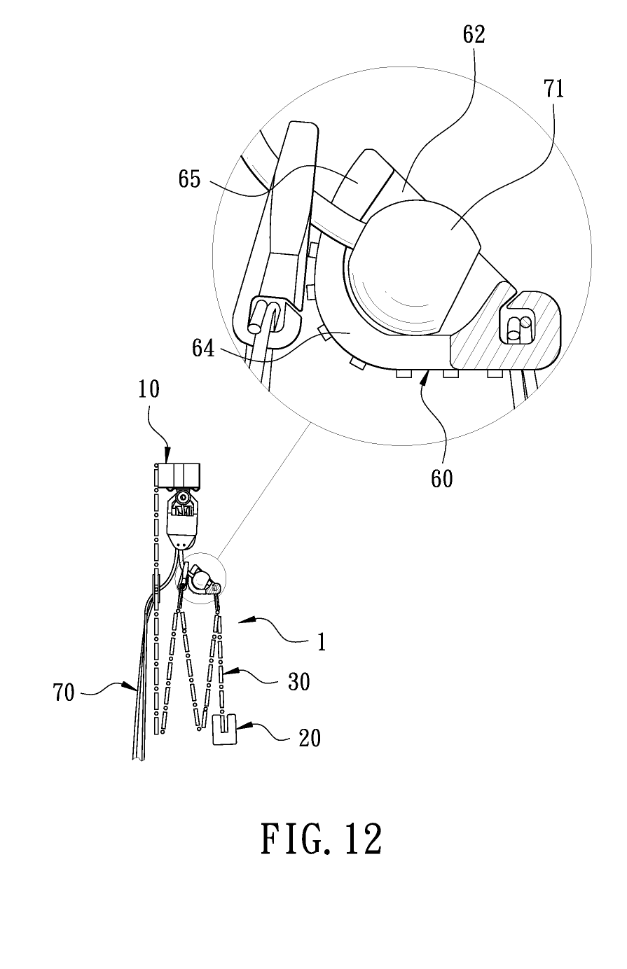

As shown in FIG. 12, when the shading unit 30 of the window blind 1 is to be upwardly folded up by pulling the lift cord 70, the lift cord 70 is not apt to slide to the opening 53 to move away from the annular secure lock 50 as it is only forced to move upwards and restricted by the blocking portion 54 as well. Restrictively guided by the groove 64, the lift cord 70 cannot help but move up vertically without affected by any component of force. When the shading unit 30 is folded up to the top, the secure ball 71 fastened with the lift cord 70 is not to loose from the accommodating chamber 62 because it is blocked by the blocking portion 65.

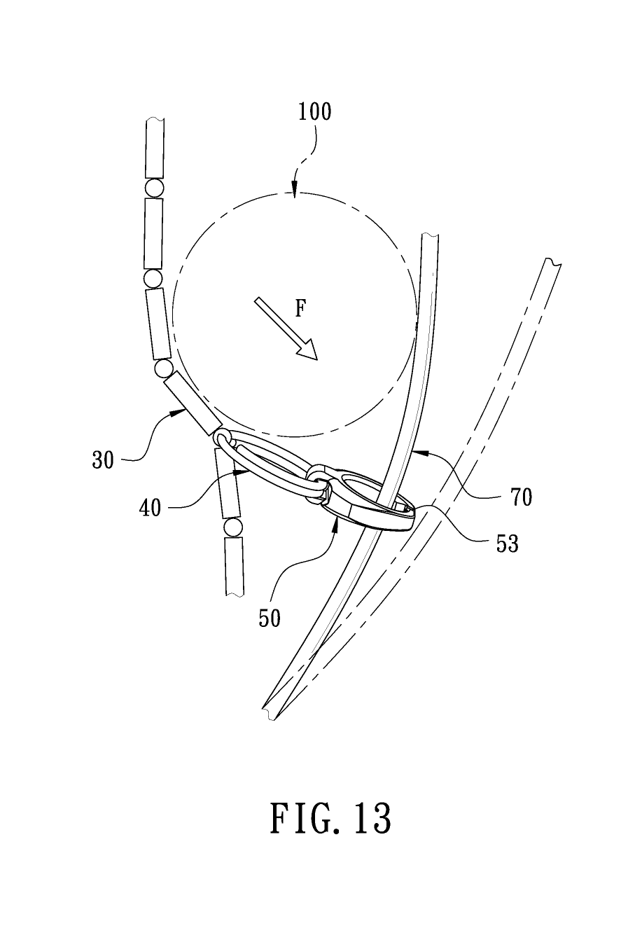

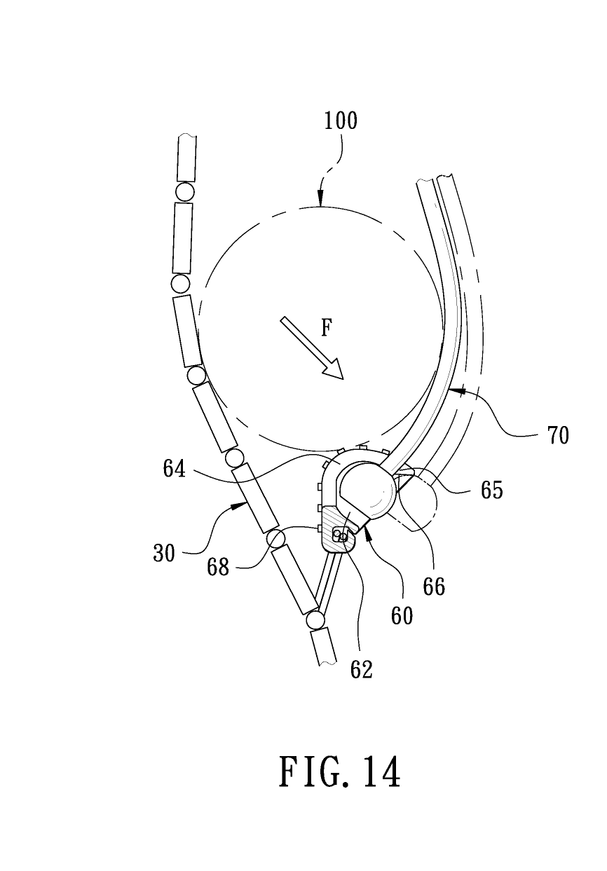

Next, as shown in FIGS. 13 and 14, while an object 100 is positioned between the shading unit 30 and the lift cord 70, the lift cord 70 is to become curved and to bear a force (F) created by the weight of the object 100, just moving toward and out of the opening 53 of the annular secure lock 50. And, as the object 100 is positioned between the shading unit 30 and the lift cord 70 close to the cap-shaped secure lock 60, the lift cord 70 is to curve owing to the force (F) created by the weight of the object 100, moving along the groove 64 to downwards compress the blocking portion 65. By the time, via the damping created by the contact of the anti-slipping members 68 with the object 100, the cap-shaped secure lock 60 is to stay still without rotation so that the secure ball 71 is to be dragged by the lift cord 70 to turn an angle and slide out of the accommodating chamber 62 through the slope 66. That is, if a child has the head accidentally trapped between the shading unit 30 and the lift cord 70, the lift cord 70 can be smoothly loosened from the annular secure locks 50 and the cap-shaped secure lock 60 so as to prevent the child from being tied to death.

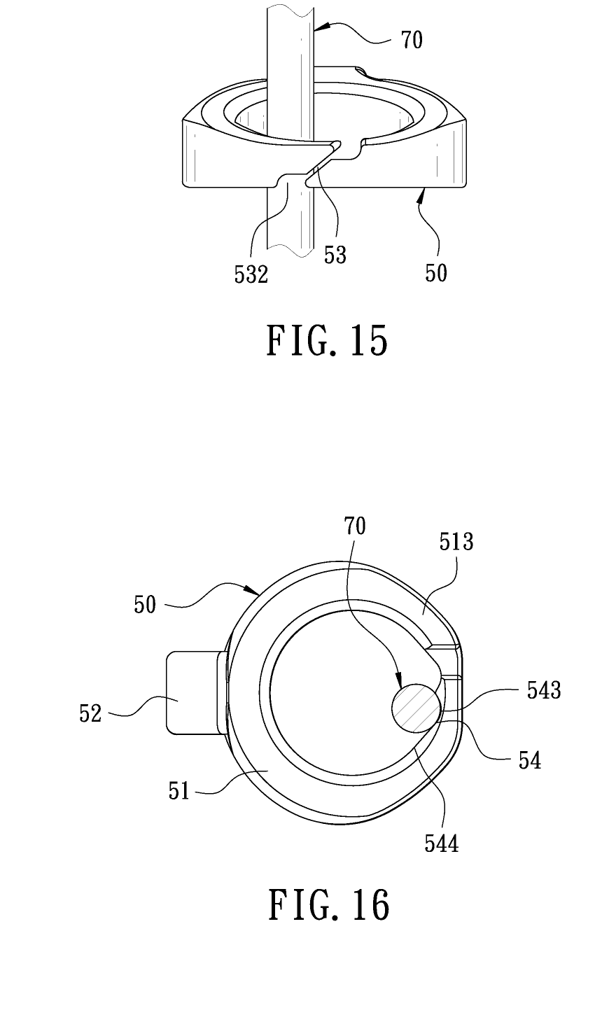

In addition, FIGS. 15 and 16 show a sixth preferred embodiment in the present invention, with the annular secure lock 50 having a similar structure as described in the previous embodiments. The opening 53 is shaped oblique relative to the axial line of the ring 51. The blocking portion 54 is provided with a concave 543 and a third blocking surface 544. With one end of the concave 543 connected with two ends of the opening 53 and with the other end of the concave 543 connected with the third blocking surface 544, the lift cord 70 can be restricted to loose from the opening 53 while being pulled up. A notch 532 is respectively formed at a top and a bottom of two ends of the ring 51 beside the opening 53, employed to let the lift cord 70 move in or out of the ring 51 smoothly. Furthermore, two end portions of the ring 51 next to the opening 53 have a thinner thickness than that close to the locking portion 52, forming as a cone 513 to keep it more elastic so that the opening 53 can be more easily expanded outward for the lift cord 70 to move away from the annular secure lock 50.

While the preferred embodiment of the invention has been described above, it will be recognized and understood that various modifications may be made therein and the appended claims are intended to cover all such modifications that may fall within the spirit and scope of the invention.

We claim:

1. A secure lock for a lift cord of a window blind or shade, said window blind or shade comprising a head rail and a shading unit, a plurality of connecting members vertically positioned in said shading unit and properly spaced apart, each said connecting member combined with an annular secure lock, the annular secure lock is replaced with a cap-shaped secure lock at the lowest connecting member when the shading unit is in an unfolded position, a lift cord strung in said annular secure locks and having a stopper connected within said cap-shaped secure lock so that said shading unit can be upwardly folded or downwardly unfolded by pulling or releasing said lift cord; said annular and cap-shaped secure lock having an opening and a groove respectively for releasing said life cord therefrom when said life cord is forced by a latitudinal component of force.

2. The secure lock for a lift cord of a window blind or shade as claimed in claim 1, wherein said annular secure lock provided with a ring having an inner annular surface and an outer annular surface, said ring further having a locking portion jointed with said outer annular surface for locking with each said connecting member, said opening formed in said outer annular surface to correspond to said locking portion and to communicate with said inner annular surface.

3. The secure lock for a lift cord of a window blind or shade as claimed in claim 1, wherein said cap-shaped secure lock provided with a cap and an accommodating chamber internally surrounded by said cap for receiving said stopper of said lift cord, a through hole formed in a top of said cap to communicate with said accommodating chamber, said groove formed in a curved portion of said cap and having one end communicated with said through hole and the other end reached a bottom edge of said cap so as to enable said lift cord to enter said through hole via said groove, a locking portion positioned on one side of said cap to correspond to said groove for engaging with each said connecting member.

4. The secure lock for a lift cord of a window blind or shade as claimed in claim 1, wherein said connecting members of said shading unit are respectively formed as a rod with a U-shaped portion formed at an intermediate section for locking with one of said annular secure lock and said cap-shaped secure lock.

5. The secure lock for a lift cord of a window blind or shade as claimed in claim 1, wherein said stopper is a secure ball formed with an accommodating chamber inside and bored with a through hole in a topside to communicate with said accommodating chamber so as to enable an end of said lift cord to get into said accommodating chamber through said through hole and form a stop portion pivotally connected with said secure ball.

6. The secure lock for a lift cord of a window blind or shade as claimed in claim 2, wherein said locking portion of said annular secure lock is formed as a C-shaped ring and provided with an engaging opening, said engaging opening is formed to outwardly expand from an inner annular surface of said locking portion.

7. The secure lock for a lift cord of a window blind or shade as claimed in claim 2, wherein said opening of said annular secure lock is shaped to gradually expand from said inner annular surface to said outer annular surface and axially parallel to said ring.

8. The secure lock for a lift cord of a window blind or shade as claimed in claim 2, wherein said opening of said annular secure lock is shaped oblique relative to an axial line of said ring, and a notch is formed at two sides of said opening respectively.

9. The secure lock for a lift cord of a window blind or shade as claimed in claim 1, wherein a blocking portion is formed on the inner annular surface next to two sides of said opening of said annular secure lock respectively.

10. The secure lock for a lift cord of a window blind or shade as claimed in claim 9, wherein said blocking portion is provided with a first blocking surface and a second blocking surface, said first blocking surface having one end connected with a side surface of said opening and the other end connected with said second blocking surface.

11. The secure lock for a lift cord of a window blind or shade as claimed in claim 9, wherein said blocking portion is provided with a concave and a third blocking surface, said concave having one end connected with said opening and the other end connected with said third blocking surface.

12. The secure lock for a lift cord of a window blind or shade as claimed in claim 2, wherein two end portions of said ring of said annular secure lock next to said opening have a smaller thickness a portion that close to said locking portion and is formed as a cone.

13. The secure lock for a lift cord of a window blind or shade as claimed in claim 3, wherein a blocking portion is formed at two inner walls of said groove of said cap-shaped secure lock respectively.

14. The secure lock for a lift cord of a window blind or shade as claimed in claim 3, wherein a slope is formed at a side surface of said blocking portion of said cap-shaped secure lock near to said accommodating chamber.

15. The secure lock for a lift cord of a window blind or shade as claimed in claim 3, wherein a plurality of anti-slipping members are formed around said through hole and said groove of said cap-shaped secure lock.

16. A secure lock for a lift cord of a window blind or shade, said window blind or comprising a head rail and a shading unit, a plurality of connecting members vertically positioned in said shading unit and properly spaced apart, each said connecting member combined with an annular secure lock, a lift cord strung in said annular secure locks and having a stopper pivotally positioned in said annular secure lock at the lowest connecting member when the shading unit is in an unfolded position, so that said shading unit can be upwardly folded or downwardly unfolded by pulling or releasing said lift cord;
said annular secure lock provided with a ring having an inner annular surface and an outer annular surface, said ring further having a locking portion jointed with said outer annular surface for locking with each said connecting member, an opening formed in said outer annular surface to correspond to said locking portion and to communicate with said inner annular surface.

17. The secure lock for a lift cord of a window blind or shade as claimed in claim 16, wherein the lowest annular secure lock is replaced with a cap-shaped secure lock, said cap-shaped secure lock provided with a cap and an accommodating chamber internally surrounded by said cap for receiving said stopper of said lift cord, a through hole formed in a top of said cap to communicate with said accommodating chamber, a groove formed in a curved portion of said cap and having one end communicated with said through hole and the other end reached a bottom edge of said cap so as to enable said lift cord to enter said through hole via said groove, a locking portion positioned on one side of said cap to correspond to said groove for engaging with each said connecting member.

18. The secure lock for a life cord of a window blind or shade as claimed in claim 16, wherein said stopper is a secure ball formed with an accommodating chamber inside and bored with a through hole in a topside to communicate with said accommodating chamber so as to enable an end of said lift cord to get into said accommodating chamber through said through hole and form a stop portion pivotally connected within said secure ball.

19. The secure lock for a life cord of a window blind or shade as claimed in claim 16, wherein said opening of said annular secure lock is shaped to gradually expand from said inner annular surface to said outer annular surface and axially parallel to said ring.

20. The secure lock for a lift cord of a window blind or shade as claimed in claim 16, wherein said opening of said annular secure lock is shaped oblique relative to an axial line of said ring.
